(19) United States
(12) Patent Application Publication
(10) Pub. No.: US 2010/0135140 A1
(43) Pub. Date: Jun. 3, 2010

(54) INFORMATION RECORDING AND REPRODUCING DEVICE

(75) Inventors: Kunihiko Horikawa, Tsurugashima-Shi (JP); Eiji Muramatsu, Tsurugashima-Shi (JP); Masahiro Miuro, Tsurugashima-Shi (JP); Atsushi Yamaguchi, Tsurugashima-Shi (JP); Kazuo Kuroda, Tsurugashima-Shi (JP); Kazutoshi Kizutoshi, Tsurugashima-Shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/593,355

(22) PCT Filed: Mar. 13, 2008
(86) PCT No.: PCT/JP2008/054646

§ 371 Date: Dec. 17, 2009

(30) Foreign Application Priority Data
Mar. 29, 2007 (JP) PCT/JP2007/056932

(51) Int. Cl. G11B 20/18; G11B 7/135

(52) U.S. Cl. 369/53.42; 369/112.03; G9B/7.112; G9B/20.046

(57) ABSTRACT

An information recording/reproducing device diffracts laser light into main- and sub-beams, irradiates evanescent light in relation to the main beam by an evanescent light generating element to a track where a recording pit provided on a recording surface of a recording medium is formed and evanescent light in relation to the sub-beam to be separated to a track where no recording pit provided on the recording surface of the recording medium is formed. A moving element moves the evanescent light generating element to change a gap with the recording surface. Return light in relation to the sub- and main-beam are received by sub- and main-light receiving elements, respectively. A control element controls the moving element so as to make the gap become a predetermined target value in accordance with a gap error signal containing a signal indicative of an amount of the return light in relation to the received sub-beam.

### TECHNICAL FIELD

The present invention relates to an information recording/reproducing apparatus which allows an evanescent light to tunnel onto a recording medium, to thereby record or reproduce information.

### BACKGROUND ART

In order to increase a recording/reproducing density of this type of information recording/reproducing apparatus, to miniaturize a beam spot is effective. To miniaturize the beam spot, it is effective to use a source of light with a short wavelength λ and to narrow it down by using a lens with a large numerical aperture NA (with a short focal length as compared with its effective diameter). Here, in order to increase the effective numerical aperture NA, a solid-immersion lens (SIL) is used which has a high refractive index. Specifically, by focusing a light which is to enter the solid-immersion lens on the end face of a solid-immersion lens (within the lens itself), it is possible to increase a refractive index n of a space reaching to the beam spot in comparison to that of the air, to thereby increase the effective numerical aperture NA. In this case, however, most of the light with an angle of incidence θ in which n·sin θ>=1 or effective NA>=1 is totally reflected, resulting in a loss of the amount of light that can reach a recording medium. Thus, by disposing the solid-immersion lens proximate to the recording medium, and by applying all the reflected light escaping from the lens end face to the proximate area onto the recording medium with it tunneling thereon as an evanescent light, the loss of the amount of light can be limited or controlled.

As described above, in order to limit or control the loss of the amount of light while increasing the numerical aperture NA, it is important to satisfy a tunneling condition, i.e. to maintain an interval (i.e. a gap) between the solid-immersion lens and the recording medium in a range of several tens to hundreds [nm]. However, such a small gap can be easily changed by (i) the deflection or runout of the recording medium associated with the rotation of the recording medium as well as (ii) the vibration or oscillation due to external disturbances. The change in the gap causes a change in the intensity of the light tunneling onto the recording medium. This causes a loss of uniformity in shape of recording pits (concavo-convex pits, recording marks, or the like) when the information is recorded onto the recording medium, and this also causes an increase in jitter due to a change in the reproduction signal amplitude when the information is reproduced from the recording medium, so that it is not preferable.

In order to avoid such problems, there has been suggested a technology associated with the gap servo control for controlling the gap between the solid-immersion lens and the recording medium in a feedback manner.

A patent document 1 discloses a technology in which there is provided a reflected light amount measurement system for measuring the amount of a reflected luminous flux from the recording medium with respect to a luminous flux which satisfies n·sinθ>=0.8 and in which the gap servo control is performed on the basis of the measured gap.

A patent document 2 discloses a technology in which the gap is monitored from the intensity of the return light reflected on a surface of the solid-immersion lens opposed to the recording medium and in which the gap servo control is performed to maintain the gap approximately constant or to maintain the intensity of the light incident to the solid-immersion lens constant with respect to this gap change.
Patent document 1: Japanese Patent Application Laid Open No. Hei 11-250484
Patent document 2: Japanese Patent Application Laid Open No. 2000-285486

### DISCLOSURE OF INVENTION

### Subject to be Solved by the Invention

However, for example, the technologies disclosed in the patent documents 1 and 2 described above may have the following problems. Namely, if the gap servo control is performed with respect to the recording medium on which the signal is recorded in advance, the concavo-convex pits or the recording marks or the like formed on tracks of the recording medium cause variations in the physical or optical height on the tracks, thereby varying a signal which quantitatively indicates the gap between the solid-immersion lens and the recording medium (i.e., a gap error signal). As a result, the gap servo control is likely destabilized.

In view of the aforementioned problems, it is therefore an object of the present invention to provide an information recording/reproducing apparatus capable of stably maintaining the gap between the solid-immersion lens and the recording medium, i.e. an information recording/reproducing apparatus for stably performing the gap servo control, in case that at least one of information recording and reproduction is performed by the evanescent light tunneling onto a recording medium.

### Means for Solving the Subject

(1)

The above object of the present invention can be achieved by an information recording/reproducing apparatus for recording or reproducing information by applying an evanescent light onto a recording medium, the information recording/reproducing apparatus provided with: a light source for emitting a laser beam corresponding to the recording or the reproduction; an optical system for leading the emitted laser beam onto the recording medium;

a diffracting device, disposed on an optical path of the laser beam in said optical system, for diffracting the led laser beam to be separated into a main beam and a sub beam; an evanescent light generating device for (i) applying an evanescent light associated with the main beam onto a track, where a recording pit is formed, of a plurality of tracks disposed at a recording surface of the recording medium, and (ii) applying an evanescent light associated with the separated sub beam onto a track, which is disposed at the recording surface and where a recording pit is not formed; a sub light receiving device for receiving a return light associated with the sub beam; a main light receiving device for receiving a return light associated with the main beam; a displacing device for displacing said evanescent light generating device in such a direction as to change a gap between the recording surface and said evanescent light generating device; and a controlling device for controlling said displacing device in such a manner that the gap can have a predetermined target value, on the basis of a gap error signal which is provided with a light amount of the received return light associated with the sub beam and a light amount of the received return light associated with the main beam.

According to the information recording/reproducing apparatus in the present invention, firstly, for example, the laser beam corresponding to the recording or the reproduction (i.e., the laser beam different depending on the recording or the reproduction) is emitted by the light source which has, for example, a semiconductor laser or the like.

The emitted laser beam is led or guided onto the recording medium by the optical system which has, for example, a collimator lens, a shaping element, or the like. Incidentally, the “recording medium” herein includes a medium having an information-recorded area, a recordable medium having an information-unrecorded area, and a hybrid medium including the both areas.

On the optical path of the laser beam in the optical system, the diffracting device which has, for example, a grating or the like is disposed, and the led laser beam is diffracted by the diffracting device to be separated into the main beam and the sub beam.

Then, in case that the divided sub beam enters the evanescent light generating device which has, for example, a solid-immersion lens or the like, the evanescent light associated with the separated sub beam is applied from the end face of the evanescent light generating device itself onto the track where the recording pit is not formed (e.g. a land track if tracking control is ON) of a plurality of tracks provided for the recording surface of the recording medium,

Here, the “recording pit” is a portion where the property of reflected light is changed by its presence or absence, to thereby express the information which is a recording or reproduction target. Incidentally, the “recording pit” includes a “concavo-convex pit” which expresses the information by using a physical concav-convex shape, a “recording mark” which expresses the information by using a change in optical property even if there is no physical concavo-convex shape as in a phase-change optical disc described in the explanation about a recording medium 100 in a first embodiment, and the like.

Moreover, the “land track” listed as one example of the “track where the recording pit is not formed” includes a land track of a so-called land/groove type recording medium in which a groove with a predetermined depth is provided as a groove track, and an area between adjacent reproduction tracks of a recording medium not provided with the groove with the predetermined depth (in other words, a recording medium provided with a formal groove track with a depth of zero) as is clear from FIG. 2. Incidentally, the “track where the recording pit is not formed” does not require that the recording pit is not formed at all. For example, if the recording pit (including a pre-pit) is formed in any of the land track and the groove track which are adjacent, it may indicate a track with a shorter recording pit length in one track length, in other words, the track having relatively less recording pits.

Moreover, the evanescent light associated with the sub beam does not require to be always applied to the track in which the recording pit is not formed.

The return light associated with the sub beam as separated above is received by the sub light receiving device which has, for example, a photoelectric conversion element or the like. The “return light associated with the sub beam” is caused by the sub beam and is preferably the return light having the information about the gap between the evanescent light generating device and the recording surface of the recording medium. Incidentally, the sub light receiving device does not need to receive the return light associated with all the sub beams but may only receive the return light associated with at least one sub beam. Of the sub beam, the return light of the light that tunnels onto the recording medium and the return light that does not tunnel onto the recording medium can be received by the different light receiving devices after the optical paths thereof are separated by, for example, a polarizing beam splitter and a non-polarizing beam splitter or the like. Here, it is found that the amount of light of the tunneling sub beam changes in accordance with the gap between the evanescent light generating device and the recording medium. Thus, information about the gap is obtained on the basis of the amount of received light of any one of the return lights, that is, for example, the return light associated with the sub beam that does not tunnel onto the recording medium.

On the other hand, the evanescent light associated with the main beam is applied onto the track, where the recording pit is formed of a plurality of tracks disposed at the recording surface of the recording medium, from the end surface common to the end surface, from which the evanescent light associated with the sub beam is generated, of the evanescent light generating device.

The return light associated with the main beam is received by the main light receiving device which has, for example, a photoelectric conversion element or the like. The “return light associated with the main beam” is caused by the main beam and is preferably the return light having the information about the gap between the evanescent light generating device and the recording surface of the recording medium. Similar to the case of the “return light associated with the sub beam”, as it is found that the light amount of the tunneling main beam changes in accordance with the gap between the evanescent light generating device and the recording medium, the information about the gap is obtained on the basis of the received light amount of any one of the return lights, that is, for example, the return light associated with the main beam that does not tunnel onto the recording medium.

Moreover, according to the displacing device which has, for example, a solid-immersion lens driving actuator using a piezoelectric element or the like, the evanescent light generating device is structured to be displaced in the direction of changing the gap between the recording surface and the end face which are displaced approximately parallel to each other.

Moreover, by the controlling device which has, for example, a differential amplification circuit or the like, gap servo control is performed as follows. In other words, the displacing device is controlled on the basis of the gap error signal including the light amount of the received return light associated with the sub beam and the light amount of the received return light associated with the main beam. Here, the “predetermined target value” is specifically a value obtained by experiments or simulations in advance as the gap in such a range that the evanescent light associated with the sub beam can tunnel onto the track in which the recording pit is not formed. Moreover, the “light amount of return light associated with the sub beam” may be the amount of light obtained by adding all or part of the return lights associated with a plurality of sub beams if the returns lights associated with the plurality of sub beams are received.

The aforementioned subject can be solved by the information recording/reproducing apparatus of the present invention performing in the above manner. In other words, the gap servo control is performed with respect to the track where the recording pit is not formed, i.e. the track in which there is little variation in physical or optical height, so that the gap can be stably maintained. In particular, since the displacing device is controlled on the basis on the gap error signal including the light amount of not only the return light associated the sub beam but also the return light associated the main beam, the used light amount increases as compared with the return light associated only with the sub beam. Consequently, the S/N ratio of the gap error signal can be improved, to thereby be extremely effective in a practical manner.

(2)

In one aspect of the information recording/reproducing apparatus of the present invention, it is further provided with an amplifying device for amplifying the light amount of the return light associated with the sub beam at a predetermined magnification.

According to this aspect, the light amount of the received light associated with the sub beam is amplified at the predetermined magnification by the amplifying device which has, for example, an amplifying circuit, and the like. Thus, the extent of contribution of the sub beam in the gap error signal can be adjusted.

(3)

In this aspect, the predetermined magnification may be set to a value which exceeds a value obtained by dividing the light amount of the received return light associated with the main beam by the light amount of the received return light associated with the sub beam.

According to this aspect, in case that the ratio of (i) the light amount of the received return light associated with the main beam to (ii) the light amount of the received return light associated with the sub beam is 4:1, the predetermined magnification is set to the value which exceeds 4/1=4. Incidentally, the “exceed” may include the sense of “larger than” or “larger than or equal”, The magnification may be set by predicting the both light amount at experiments or simulations in advance, or set in accordance with the light amount which is emitted from the sub receiving device and the main receiving device in recording/reproducing later. If the magnification is set as above, the extent of contribution of the light amount of the received light associated with the sub beam exceeds that of the received light associated with the main beam in the gap error signal. Thus the S/N can be maintained with keeping the capture range of the signal level of the gap error signal as much as possible.

(4)

In this aspect, the predetermined magnification may be set to a value obtained by dividing the light amount of the received return light associated with the main beam by the light amount of the received return light associated with the sub beam.

According to this aspect, in case that the ratio of (i) the light amount of the received return light associated with the main beam to (ii) the light amount of the received return light associated with the sub beam is 4:1, the predetermined magnification is set to 4/1=4. The magnification may be set by predicting the both light amount at experiments or simulations in advance, or set in accordance with the light amount which is emitted from the sub receiving device and the main receiving device in recording/reproducing later. If the magnification is set as above, the extent of contribution of the light amount of the received light associated with the sub beam become approximately equal to that of the received light associated with the main beam in the gap error signal. The height variation of the emitting position on the recording surface for the sub beam and the main beam is cancelled. Thus the gap error control can be stabilized. Incidentally, the “a value obtained by dividing” is a so-called quotient. But the digit number used in accordance with the required accuracy may be appropriately changed and moreover the approximate value may be used.

(5)

In another aspect of the information recording/reproducing apparatus of the present invention, the recording pit is formed in a concave shape.

According to this aspect, if the recording pit is formed in the concave shape, the track where the recording pit is not formed is higher than the bottom surface of the recording pit. Thus, the track where the recording pit is not formed can be an obstacle to perform the gap servo control on the reading track where the recording pit is formed. In other words, the capture range of the gap can be wasted. In this case, the gap servo control is preferably performed on the track where the recording pit is not formed. Namely, it can be said that using the return light associated with the sub beam for the gap error signal is more efficient than using the return light associated with the main beam.

(6)

In another aspect of the information recording/reproducing apparatus of the present invention, it is further provided with a signal generating device, disposed at the optical path of the laser beam in said optical system, for generating the gap error signal corresponding to a magnitude of the gap between the evanescent light generating device and the recording surface.

According to this aspect, the gap error signal with the magnitude corresponding to the gap between the recording surface and the evanescent light generating device is generated by the signal generating device which is disposed on the optical path of the laser beam in the optical system and which has, for example, a polarizing beam splitter, a non-polarizing beam splitter, an adder, a differential amplifier, and the like.

(7)

In this aspect, if the track where the recording pit is formed and the track where the recording pit is not formed are alternately placed in the recording medium, an optical condition in said optical system is set such that a difference between an irradiation position on the recording surface of the evanescent light associated with the separated sub beam and an irradiation position on the recording surface of the evanescent light associated with the main beam is an odd multiple of a half value of a track pitch in a radial direction of the recording medium.

According to this aspect, if the irradiation position on the recording medium of the evanescent light associated with the main beam belongs to the track where the recording pit is formed (e.g. groove track), that of the sub beam naturally belongs to the track where the recording pit is not formed (e.g. land track). Therefore, it is possible to preferably perform the gap servo control on the basis of the evanescent light associated with the sub beam while forming or reading the recording pit on the basis of the evanescent light associated with the main beam.

Incidentally, the “half value of the track pitch” includes not only a half value in a strict sense but also an approximately half value in practical;

namely, it in effect allows a margin in a range that allows the effect of the present invention to be received to a greater or lesser extent.

(8)

In this aspect, the evanescent light generating devices associated with the main beam and the sub beam may be solid-immersion lenses or solid-immersion mirrors.

According to this aspect, the main beam and the sub beam which enter the solid-immersion lens are focused on the end face of the solid-immersion lens opposed to the recording medium and are partially reflected. Here, in a portion in which total reflection is performed with the angle of incidence exceeding a critical angle, the evanescent light escapes from the end face of the solid-immersion lens from to the recording medium side. In this manner, the evanescent lights associated with the main beam and the sub beam can be generated.

(9)

In another aspect of the information recording/reproducing apparatus of the present invention, the diffracting device separates the sub beam into at least ±first-order lights, and the gap error signal is generated at least from the ±first-order lights.

According to this aspect, by the evanescent light generating device associated with the sub beam, the evanescent light corresponding to the ±first-order lights is generated, and it is reflected on the recording surface of the recording medium, thereby to be the return light. The return light is received by the sub light receiving device which has, for example, a photoelectric conversion element or the like. The gap error signal is generated on the basis of at least the light receiving signal of the evanescent light associated with the first-order lights. As a result, it is possible to preferably perform the gap servo control on the basis of the evanescent light associated with the ±first-order lights while forming or reading the recording pit on the basis of the evanescent light associated with the main beam. Incidentally, the expression “at least from the ±first-order lights” in effect does not restrict the separation into sub beams of a second order or more, and the expression also does not restrict that the control is performed by using, for example, the ±second-order sub beam in addition to or instead of the first-order sub beam as long as a sufficient amount of light can be ensured.

Incidentally, the gap error signal is not necessarily generated from all the sub beams but may be generated from at least one sub beam.

As explained above, according to the information recording/reproducing apparatus of the present invention, it is provided with the light source, the optical system, the diffracting device, the evanescent light generating device, the sub light receiving device, the displacing device, and the controlling device, so that the gap servo control can be stably performed.

The operation and other advantages of the present invention will become more apparent from the embodiments explained below.

### BRIEF DESCRIPTION OF DRAWINGS

FIG. 1 is a schematic diagram showing the basic structure of an information recording/reproducing apparatus 1 in a first embodiment.

FIG. 2 is a schematic diagram showing the placement of evanescent light on the recording medium in the first embodiment.

FIG. 3 is a cross sectional view showing a gap between a solid-immersion lens 21 and a recording medium 100 in a case where evanescent light SBE associated with a sub beam SB is placed on a non-pit (or land track L), in the first embodiment.

FIG. 4 is a characteristic diagram showing a relation of the signal level of a gap error signal GE and the gap between the solid-immersion lens 21 and the recording medium 100, in the first embodiment.

FIG. 5 is a schematic diagram showing the placement of evanescent light MBE associated with a main beam MB on the recording medium 100, in a comparative example.

FIG. 6 is a cross sectional view showing the gap between the solid-immersion lens 21 and the recording medium 100 in case where the evanescent light MBE associated with the main beam MB is placed on a groove track G in which a concave pit PT1 is formed, in the comparative example.

FIG. 7 is a characteristic diagram showing the relation of the signal level of the gap error signal GE and the gap between the solid-immersion lens 21 and the recording medium 100, in the comparative example.

FIG. 8 is a schematic diagram showing the basic structure of an information recording/reproducing apparatus 1 in a second embodiment.

FIG. 9 is a schematic diagram showing the basic structure of an information recording/reproducing apparatus 1 in a third embodiment.

FIG. 10 is a schematic diagram showing the placement of the evanescent light associated with each of the main beam MB and the sub beams SB on the recording medium 100 in the third embodiment.

FIG. 11 is a cross sectional view showing the gap between the solid-immersion lens 21 and the recording medium 100 in a case where the main beam MB is placed on a convex pit PT2, in the third embodiment.

FIG. 12 is a characteristic diagram showing the relation of (i) the signal level of the gap error signal GE and (ii) the gap between the solid-immersion lens 21 and the recording medium 100, in case where the main beam MB is placed on the convex pit PT2, in the third embodiment.

FIG. 13 is a schematic diagram showing the placement of evanescent light on the recording medium 100, in a comparative example.

FIG. 14 is a characteristic diagram showing the signal level of the gap error signal GE obtained on an information recording/reproducing apparatus in the comparative example.

FIG. 15 is a schematic diagram showing the placement of the evanescent light on the recording medium 100, in a fourth embodiment.

FIG. 16 is a characteristic diagram showing the signal level of the gap error signal GE obtained on an information recording/reproducing apparatus 1 in the fourth embodiment.

FIG. 17 is a schematic diagram showing the placement of the evanescent light on the recording medium 100, in a comparative example.

FIG. 18 is a characteristic diagram showing the signal level of the gap error signal GE obtained on an information recording/reproducing apparatus in the comparative example.

FIG. 19 is a schematic diagram showing the placement of the evanescent light on the recording medium 100, in a fifth embodiment,

FIG. 20 is a characteristic diagram showing the signal level of the gap error signal GE obtained on an information recording/reproducing apparatus 1 in the fifth embodiment.

### DESCRIPTION OF REFERENCE CODES

1 information recording/reproducing apparatus
11 laser diode
12 collimator lens
13 shaping element
14 diffraction grating
15 non-polarizing beam splitter (NBS)
16 polarizing beam splitter (PBS)
17 beam expander
18 quarter wave plate (QWP)
19 reflecting mirror
20 objective lens
200 tracking actuator
21 solid-immersion lens
210 gap actuator
30 light receiving element
31 light receiving element
32 light receiving element
311 sub light receiving device
312 main light receiving device
313 sub light receiving device
314 adder
315 amplifier
3141 summing amplifier
3142 adder
3161 switch
3162 switch
40 judgment device
100 recording medium
G groove track
L land track
PT1 concave pit
PT2 convex pit
MB main beam
SB sub beam
MBE evanescent light associated with a main beam
SBE evanescent light associated with a sub beam

### BEST MODE FOR CARRYING OUT THE INVENTION

Hereinafter, the best mode for carrying out the present invention will be explained in each embodiment on the basis of the drawings.

### (1) First Embodiment

### (Basic Structure and Operation)

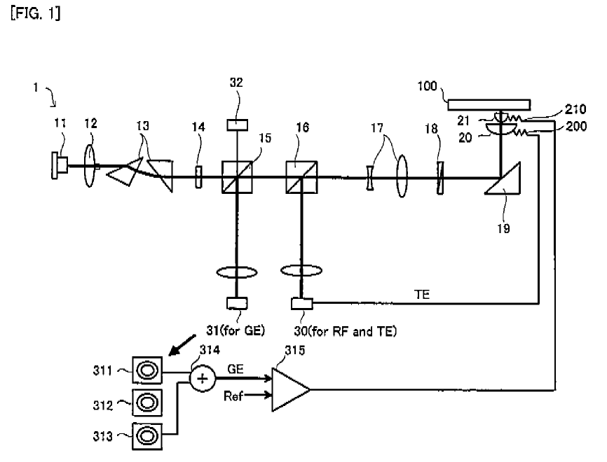

The basic structure and operation of an information recording/reproducing apparatus in a first embodiment will be explained with reference to FIG. 1 to FIG. 7.

FIG. 1 is a schematic diagram showing the basic structure of an information recording/reproducing apparatus 1 in the first embodiment.

As shown in FIG. 1, the information recording/reproducing apparatus 1 in the first embodiment is provided with a laser diode 11, an optical system, various light receiving elements, and various actuators. The information recording/reproducing apparatus 1 applies the evanescent light onto a recording medium 100, thereby recording or reproducing information.

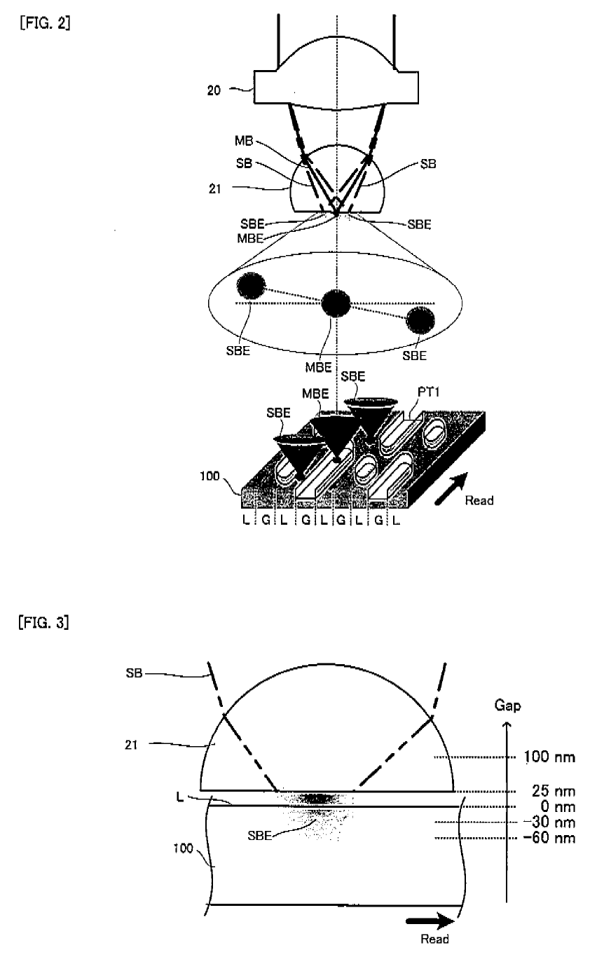

The recording medium 100 is, for example, an magneto-optical disc, a phase-change optical disc, or an optical disc master having a photoresist layer, and it is rotationally driven by a spindle motor (not illustrated) in the recording/reproduction. In a data recording layer on the surface of the recording medium 100, tracks such as a groove track G and a land track L are alternately provided, spirally or concentrically, centered on a center hole (refer to FIG. 2). Incidentally, in FIG. 1, the groove track G may be a track in which a recording pit PT1 is simply formed, and it is a formality with a depth of zero other than the recording pit PT1 and a so-called groove is not necessarily formed. Incidentally, considering that the tunneling distance of evanescent light is on the order of nanometers, as described later, a cover layer for protecting the data recording layer is preferably extremely thin (specifically, 100 [nm] or less).

If a drive current associated with the recording or reproduction is fed from a LD driver (not illustrated), a laser beam with a predetermined wavelength is emitted from the laser diode 11. The emitted laser beam is changed to a parallel luminous flux by a collimator lens 12 before the light intensity of a flux cross section is uniformed on a shaping element 13, and is divided into a main beam MB and sub beams SB on a diffraction grating 14. Then, each of them is transmitted through a non-polarizing beam splitter 15 and a polarizing beam splitter 16, is expanded to a parallel luminous flux of a predetermined magnification by a beam expander 17, is converted to circularly polarized light on a quarter wave plate 18, is raised toward the recording medium 100 on a reflecting mirror 19, is focused by an objective lens 20, and then enters a solid-immersion lens 21.

The main beam MB and the sub beams SB entering the solid-immersion lens 21 are focused and reflected on the end face of the solid-immersion lens 21 opposed to the recording medium 100. Here, in case of total reflection with the angle of incidence exceeding a critical angle, the evanescent light escapes from the end face of the solid-immersion lens 21 to the air side (i.e. to the recording medium 100 side). The escaped evanescent light exponentially attenuates, so that the tunneling does not occur on the recording medium 100 unless the gap between the solid-immersion lens 21 and the recording medium 100 is less than the wavelength of the laser beam, e.g. 100 [nm] or less.

This will be shown in FIG. 2 and FIG. 3, FIG. 2 is a schematic diagram showing the placement of evanescent light on the recording medium 100 in the first embodiment. The drawings in FIG. 2 are, from the top, a cross sectional view showing the objective lens 20 and the solid-immersion lens 21, a top view showing the placement of each evanescent light on the recording medium 100, and its perspective view. FIG. 3 is a cross sectional view showing the gap between the solid-immersion lens 21 and the recording medium 100 in case that the evanescent light SBE associated with a sub beam SB is placed on a non-pit (or land track L).

As shown in FIG. 2, the tracking servo control is performed by a tracking actuator 200 such that the evanescent light SBE associated with the sub beam SB tunnels onto the land track L whereas the evanescent light MBE associated with the main beam MB tunnels onto the groove track G. FIG. 3 is an enlarged view showing the light focused portion of the sub beam SB, In FIG. 3, the gap servo control is performed such that the gap between the solid-immersion lens 21 and the recording medium 100 is, for example, 25 [nm]. In this case, since the concave pit PT1 is not formed in the land track L onto which the evanescent light SBE associated with the sub beam SB tunnels, there is no influence of variations in height, as described later in comparison with a comparative example, so that the gap servo control can be stabilized,

Back in FIG. 1, the light that does not tunnel onto the recording medium 100 is reflected on the bottom surface of the solid-immersion lens 2L

Here, the light that tunnels and the light that does not tunnel onto the recording medium 100 of the return light have different optical paths. Specifically, both of the return lights are circularly polarized lights but reverse to each other, so that the linearly polarized lights obtained by converting the both return lights on the quarter wave plate 18 have different polarization components, and the optical paths are separated on the polarizing beam splitter 16. Namely, the return light of the light that tunnels onto the recording medium 100 is reflected and received by a light receiving element 30, whereas the return light of the light that does not tunnel onto the recording medium 100 is transmitted through and some percentage thereof is reflected by the non-polarizing beam splitter 15 and is received by a light receiving element 81.

The light receiving element 30 is, for example, a divided light detector in which a light receiving surface is divided into a plurality of areas (four areas as one example). With an output signal corresponding to the light received in each area, a reproduction signal, a tracking error signal for tracking servo control by the tracking actuator 200, and the like are generated.

The light receiving element 31 includes a main light receiving device 312 for receiving return light associated with the main beam MB and sub light receiving devices 311 and 313 for receiving return lights associated with the sub beams SB. One of the sub light receiving devices 311 and 313 receives first-order light, and the other receives minus first-order light. With output signals corresponding to the lights received on the sub light receiving devices 311 and 313 being added at a predetermined ratio on an adder 314 at a subsequent stage, or with one of the output signals being used as it is, the gap error signal GE for the gap servo control between the solid-immersion lens 21 and the recording medium 100 is generated. Then, the generated gap error signal GE and a reference signal Ref corresponding to the target value of the gap are inputted to an amplifier 315 at a subsequent stage as a differential input. In accordance with a difference between the both input signals, a gap actuator 210 is driven and is adjusted in a feedback manner such that the gap between the solid-immersion lens 21 and the recording medium 100 has the target value.

A light receiving element 32 is a photodetector for receiving the light reflected by the non-polarizing beam splitter 15, and its output signal can be used for light output control of the laser diode 11.

### Comparison with Comparative Example

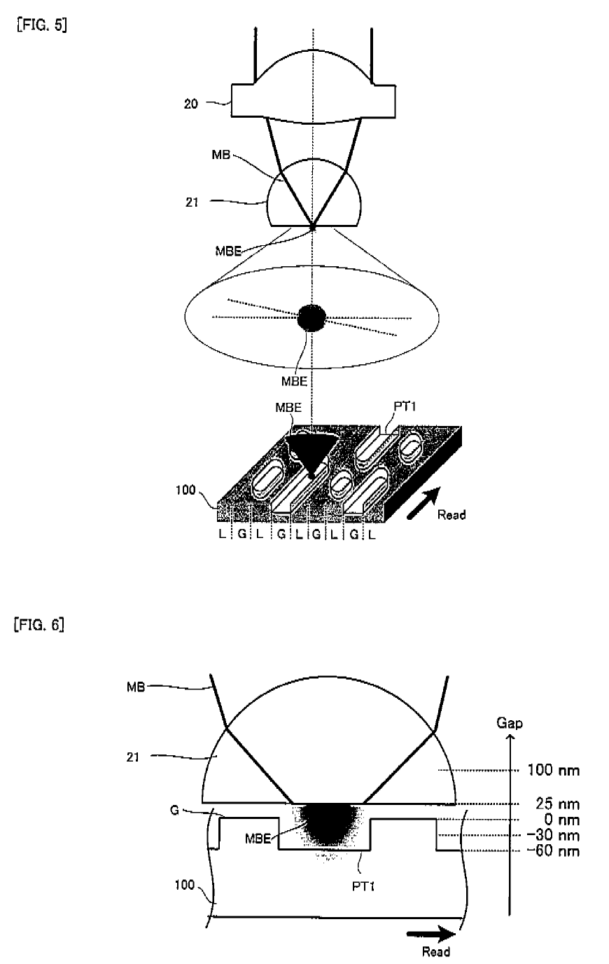

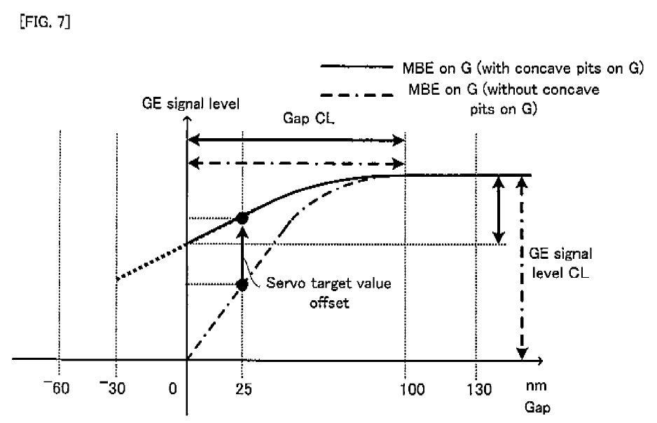

According to the information recording/reproducing apparatus 1 in the first example as constructed above, the aforementioned subject can be solved as detailed below in contrast with a comparative example shown in FIG. 5 to FIG. 7. FIG. 5 is a schematic diagram showing the placement of the evanescent light MBE associated with the main beam MB on the recording medium 100, in the comparative example. The drawings in FIG. 5 are, from the top, a cross sectional view showing the objective lens 20 and the solid-immersion lens 21, a top view showing the placement of the evanescent light MBE associated with the main beam MB on the recording medium 100, and its perspective view. FIG. 6 is a cross sectional view showing the gap between the solid-immersion lens 21 and the recording medium 100 in a case where the evanescent light MBE associated with the main beam MB is placed on the groove track G in which the concave pit PT1 is formed. FIG. 7 is a characteristic diagram showing the relation of the signal level of the gap error signal GE and the gap between the solid-immersion lens 21 and the recording medium 100, in the comparative example. More specifically, it is a characteristic diagram in each of a case where the concave pit PT1 is formed in the groove track G and the evanescent light MBE associated with the main beam MB is placed on the concave pit PT1 and a case where the evanescent light MBE associated with the main beam MB is placed on the groove track in which the concave pit PT1 is not formed.

As shown in FIG. 5, in the comparative example, the sub beam SB is not separately generated. Thus, in the information recording or reproduction, the evanescent light MBE associated with the main beam MB is placed on the groove track G in which the pit PT1 is formed. At this time, as shown in FIG. 6, the evanescent light MBE associated with the main beam MB tunnels onto the groove track G. Here, since the concave pit PT1 is formed in the groove track G, the variations in the height occurs. If the peak of the concave pit PT1 (in other words, the surface of the groove track G) is a real gap reference position (0 [nm]) of the recording medium 100, the average depth of the concave pit PT1 is 60 [nm]×50[%]=30 [nm] when a Duty ratio of the recording medium 100 is 50%. At this time, as shown in FIG. 7, a virtual gap reference position of the recording medium 100 in which the concave pit PT1 is formed can be considered minus 30 [nm] which is 30 [nm] lower than the real gap reference position 0 [nm]. In reality, however, the solid-immersion lens 21 cannot be brought close to the area between the virtual gap reference position (−30 [nm]) and the real gap reference position (0 [nm]), so that a range by the depth of the concave pit PT1 is wasted, and that a capture range CL of the signal level of the gap error signal GE is relatively narrowed. Therefore, the sensitivity of the gap servo control is reduced, and the control is destabilized. In addition, in view of the variations in height of the groove track Gas described above, the gap obtained on the basis of the signal level of the gap error signal generated on the light receiving element 31 is considered to be offset, and it is hard to accurately observe the real gap,

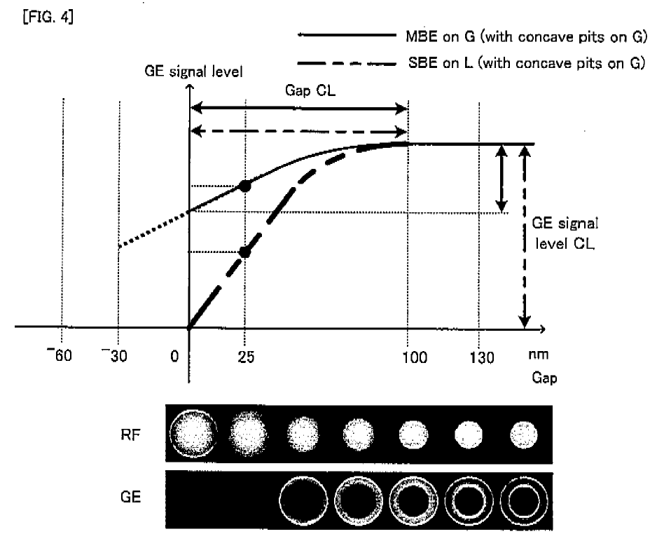

However, particularly in the embodiment, as explained with reference to FIG. 1 to FIG. 3, the concave pit PT1 is not formed in the land track L on which the evanescent light SBE associated with the sub beam SB tunnels. Therefore, the error signal GE generated on the basis of the return light associated with the sub beam SB reflected by the land track L has no or little influence of the variations in height of the track. Thus, specifically, a characteristic diagram as shown in FIG. 4 can be obtained. Here, FIG. 4 is a characteristic diagram showing a relation of the signal level of the gap error signal GE and the gap between the solid-immersion lens 21 and the recording medium 100, in the first embodiment. In more detail, it is a characteristic diagram in each of a case where the concave pit PT1 is formed in the groove track G and the evanescent light MBE associated with the main beam MB is placed on the concave pit PT1 and a case where the evanescent light SBE associated with the sub beam SB is placed on the land track L in which the concave pit PT1 is not formed although the concave pit PT1 is formed in the groove track G. The drawing at the subsequent stage is a theoretical view showing a reproduction signal RF corresponding to a gap axis and the gap error signal GE.

As shown in FIG. 4, even if the concave pit PT1 is formed in the groove track G, if the evanescent light SBE associated with the sub beam SB is placed on the land track L in which the concave pit PT1 is not formed, it is possible to receive the same benefits as in “the case where the evanescent light MBE associated with the main beam MB is placed on the groove track G in which the concave pit PT1 is not formed” in FIG. 7. In other words, the influence of the variations in height by the concave pit PT1 is reduced, and the capture range CL of the signal level of the gap error signal GE is expanded, so that the gap servo control can be stabilized. In addition, it is possible to more accurately observe the real gap, and it is extremely effective in practice.

An explanation will be given on the recording operation and the reproduction operation of the information recording/reproducing apparatus 1 under the condition that the gap servo control is stably performed as described above.

### (Recording Operation)

In the recording onto the recording medium 100, by modulating a drive current of the laser diode 11 in accordance with a binary signal (or record signal) to be recorded, the tunneling light intensity of the evanescent light is also modulated in accordance with the record signal, by which the concave pit PT1 (refer to FIG. 2) is formed in the groove track G of the recording medium 100. Here, according to the embodiment, since the gap servo control is stably performed, the gap between the solid-immersion lens 21 and the recording medium 100 is stably maintained to the target value. As a result, it is possible to perform good recording in which the concave pit PT1 is uniformly formed.

### (Reproducing Operation)

In the reproduction from the recording medium 100, the reproduction signal is obtained by receiving the reflected light by the evanescent light that tunnels onto the recording medium 100 on the light receiving element 30. Here, according to the embodiment, since the gap servo control is stably performed, the gap between the solid immersion lens 21 and the recording medium 100 is stably maintained to the target value. As a result, it is possible to avoid the change in reproduction signal amplitude and to perform good reproduction.

### (2) Second Embodiment

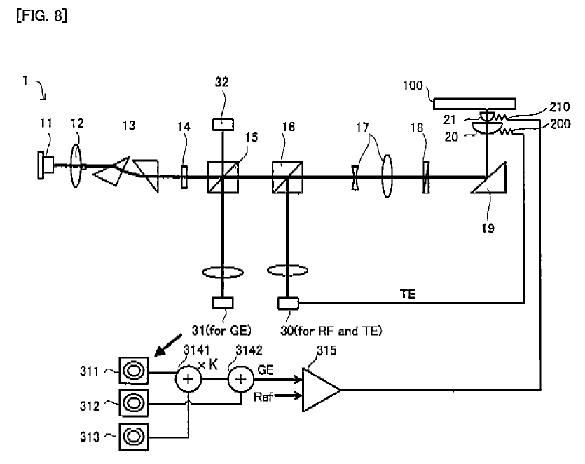

Next, the basic structure and the operation of an information recording/reproducing apparatus 1 in a second embodiment will be explained with reference to FIG. 8 in addition to FIG. 1 to FIG. 4. In FIG. 8, the same constituents as those in FIG. 1 will carry the same referential numerals, and the detailed explanation thereof will be omitted, as occasion demands.

In particular, the second embodiment is an embodiment for solving the subject in the first example, i.e. the subject that S/N is bad because the sub beam SB used in the first embodiment has the smaller amount of light than the main beam.

FIG. 8 is a schematic diagram showing the basic structure of the information recording/reproducing apparatus 1 in the second embodiment.

As shown in FIG. 8, in order to further solve the aforementioned subject, the information recording/reproducing apparatus 1 in the second embodiment is provided with a summing amplifier 3141 and an adder 3142, instead of the adder 814, as opposed to the first embodiment. Then, the gap error signal GE is generated as follows.

Firstly, by the summing amplifier 3141 having an adding and differential amplification circuit, the output signals corresponding to the lights received on the sub light receiving devices 311 and 313 are added to each other and amplified by K (wherein K is a constant or variable). Then, by the adder 3142, the amplified output and the output signal corresponding to the light received by the main light receiving device 312 are added, and as a result, the gap error signal GE is generated.

The gap error signal GE as generated above includes not only a signal component of the sub beam SB but also a signal component of the main beam MB. Although the signal component of the main beam MB has the influence of variations in height by the concave pit PT1 in comparison to the signal component of the sub beam SB, it indicates the gap between the solid-immersion lens 21 and the recording medium 100. Therefore, the addition of the signal component of the main beam MB increases the amount of light used in comparison to the first embodiment and improves the S/N of the gap error signal GE, thereby providing highly accurate gap servo control.

However, if the signal component of the main beam MB to be added is too large in comparison to the signal component of the sub beam SB, such a problem recurs that the capture range of the signal level of the gap error signal GE is narrowed (refer to the comparative example in FIG. 7). Thus, the addition is preferably performed to the extent that the minimum S/N is ensured. In other words, the extent of contribution of the signal component of the sub beam SB is desirably greater than or equal to that of the main beam MB. For example, if “(the signal component of the sub beam SB received by the sub light receiving device 311): (the signal component of the main beam MB received by the main light receiving device 312): (the signal component of the sub beam SB received by the sub light receiving device 313”) in the signal ratio=1:8:1, the magnification K of the summing amplifier 3141 satisfies K(1+1)>=8; namely, K is desirably greater than or equal to 4.

### (3) Third Embodiment

Next, the basic structure and the operation of an information recording/reproducing apparatus 1 in a third embodiment will be explained with reference to FIG. 9 to FIG. 12 in addition to FIG. 1 to FIG. 4. In FIG. 9, the same constituents as those in FIG. 1 will carry the same referential numerals, and the detailed explanation thereof will be omitted, as occasion demands.

In particular, the third embodiment is an embodiment for further solving the other subject in the first example, i.e. the subject that the first embodiment is effective if the pit is concave but is disadvantageous if the pit is convex.

FIG. 9 is a schematic diagram showing the basic structure of the information recording/reproducing apparatus 1 in the third embodiment.

As shown in FIG. 9, in order to further solve the aforementioned subject, the information recording/reproducing apparatus 1 in the third embodiment is provided with a judgment device 40, a switch 3161, and a switch 3162, as opposed to the first embodiment. Then, the gap error signal GE is generated as follows.

Before starting to read the recording medium 100, for example, it is judged whether the pit shape of the recording medium 100 is concave or convex by the judgment device 40 including a light receiving element and a control circuit. The judgment is performed, for example, on the basis of information recorded in a BOA provided out of the recording surface of the recording medium 100. Alternatively, the judgment may be performed by generating the gap error signal GE and by comparing it with the signal patterns in a concavo-convex state which are recorded in advance.

The switch 3161 switches a signal which is the generating source of the gap error signal GE between a signal from the main light receiving device 312 and a signal obtained by adding those from the sub light receiving devices 311 and 313, under the control of the judgment device 40.

The switch 3162 switches the reference signal corresponding to the target value of the gap between RF1 and RF2. Here, the reference signal RF1 is a reference signal when the signal which is the generating source of the gap error signal GE is the signal from the main light receiving device 312, and the reference signal RF2 is a reference signal when the signal which is the generating source of the gap error signal GE is the signal obtained by adding those from the sub light receiving devices 311 and 313.

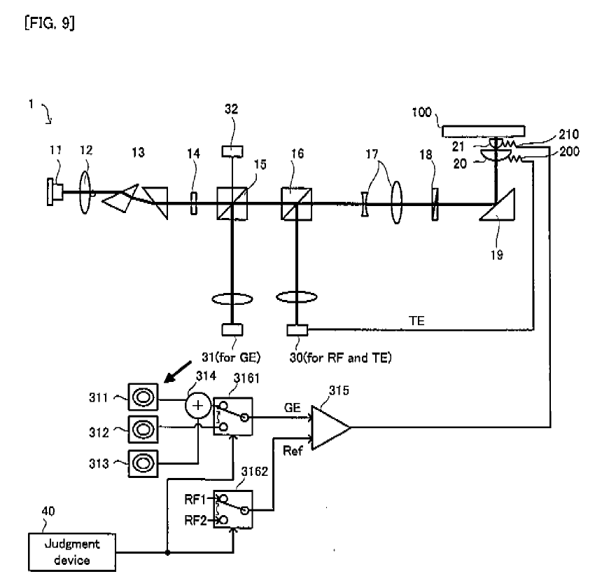

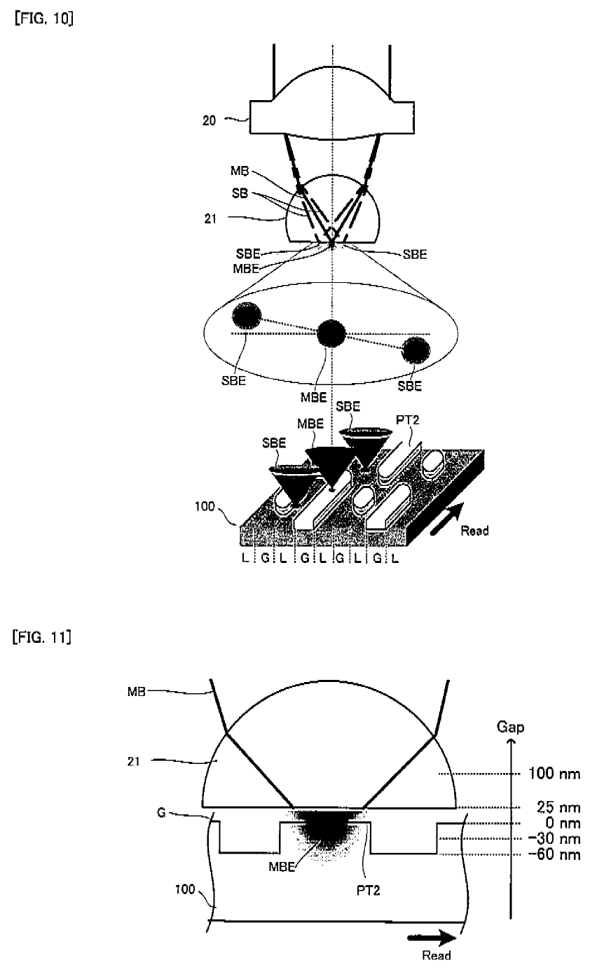

Here, with regard to the subject related to the concavoconvex state, an explanation will be added with reference to FIG. 10 to FIG. 12. Here, FIG. 10 is a schematic diagram showing the placement of the evanescent light associated with each of the main beam MB and the sub beams SB on the recording medium 100 in the third embodiment. The drawings in FIG. 10 are, from the top, a cross sectional view showing the objective lens 20 and the solid-immersion lens 21, a top view showing the placement of each evanescent light on the recording medium 100, and its perspective view. Incidentally, in FIG. 10, the groove track G may be a track in which a recording pit PT2 is simply formed, and it is a formality with a depth of zero other than the recording pit PT2 and a so-called groove is not necessarily formed. FIG. 11 is a cross sectional view showing the gap between the solid-immersion lens 21 and the recording medium 100 in a case where the main beam MB is placed on the convex pit PT2, in the third embodiment. FIG. 12 is a characteristic diagram showing the relation of the signal level of the gap error signal GE and the gap between the solid-immersion lens 21 and the recording medium 100, in the case where the main beam MB is placed on the convex pit PT2, in the third embodiment.

As shown in FIG. 10, since the both sides of the land track L onto which the evanescent light SBE associated with the sub beam SB tunnels are sandwiched between the convex pits PT2, the gap between the solid-immersion lens 21 and the recording medium 100 cannot be reduced beyond the height of the concave pit PT2 (e.g. 60 [nm]). In other words, the capture range of the gap is wasted by that much, and the gap servo control needs to be performed in the rest which is 100−60=40 [nm] (refer to FIG. 12). In contrast, the tracks on the both sides of the groove track G onto which the evanescent light MBE associated with the main beam MB tunnels are lower (i.e. deeper) than the concave pit PT2 (i.e. deeper). Therefore, although there are variations in height caused by the convex pit PT2 (refer to FIG. 11), the solid-immersion lens 21 is not interrupted by the convex pit PT2 formed in the tracks on the both sides. Thus, the gap servo control can be performed in the wider capture range (refer to FIG. 12). Therefore, if the pit formed in the groove track G is convex, it is advisable to use the return light of the main beam MB for the gap error signal GE.

On the basis of the aforementioned viewpoint, the information recording/reproducing apparatus 1 in the third embodiment operates as follows. In other words, in accordance with the aforementioned judgment result by the judgment device 40, it is determined whether or not the sub beam SB is used for the gap error signal GE. If it is judged to be concave, the signal which is the generating source of the gap error signal GE is preferably the signal obtained by adding those from the sub light receiving devices 311 and 313, and the switch 3161 and the switch 3162 are changed as such, to the same effect as in the first embodiment. On the other hand, if it is judged to be convex, as explained with reference to FIG. 10 to FIG. 12, the signal which is the generating source of the gap error signal GE is preferably the signal from the main light receiving device 312, and the switch 3161 and the switch 3162 are changed as such.

As described above, according to the third embodiment, the gap servo control based on the appropriate signal is performed in accordance with the concavo-convex state of the pit of the recording medium 100, so that it is extremely useful in practice.

### (4) Fourth Embodiment,

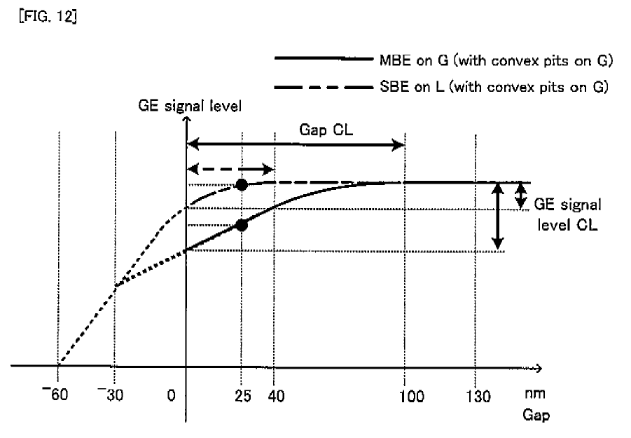

Next, the basic structure and the operation of an information recording/reproducing apparatus 1 in a fourth embodiment will be explained with reference to FIG. 13 to FIG. 16. In each drawing, the same constituents as those in any of FIG. 1 to FIG. 12 will carry the same referential numerals, and the detailed explanation thereof will be omitted, as occasion demands.

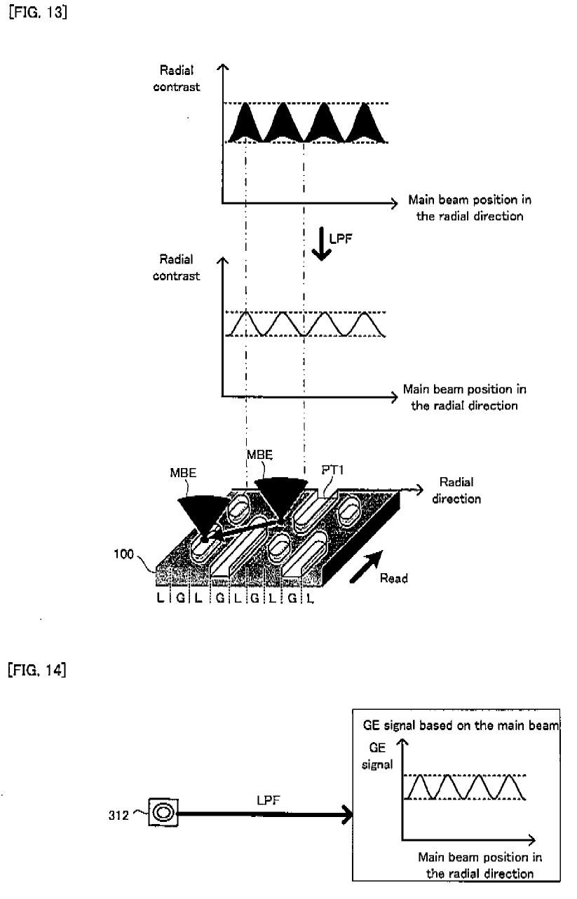

FIG. 13 is a schematic diagram showing the placement of evanescent light on the recording medium 100, in a comparative example. FIG. 14 is a characteristic diagram showing the signal level of the gap error signal GE obtained on an information recording/reproducing apparatus in the comparative example.

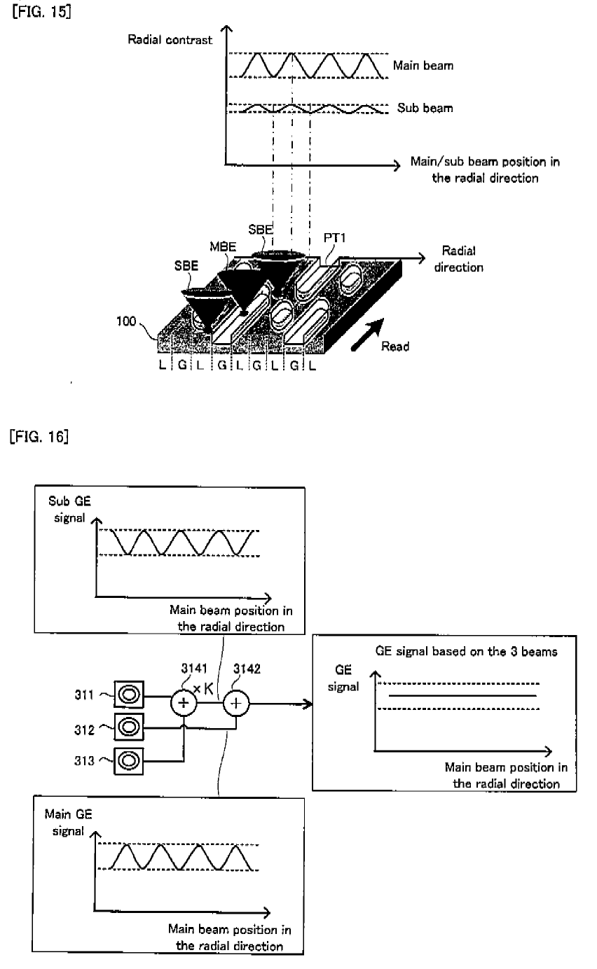

FIG. 15 is a schematic diagram showing the placement of evanescent light on the recording medium 100, in the fourth embodiment. FIG. 16 is a characteristic diagram showing the signal level of the gap error signal GE obtained on the information recording/reproducing apparatus 1 in the fourth embodiment.

The fourth embodiment is an embodiment for individually and specifically explaining that the benefits shown in the first embodiment are effective when the tracking control is not only ON but also OFF (e.g. in a seek operation) on the flat recording surface where the recording pit PT1 is formed in the convex shape or in the concave shape.

Incidentally, in the fourth embodiment, the groove track G is a track in which the recording pit PT1 is simply formed, and it is a formality with a depth of zero other than the recording pit PT1.

In the comparative example, as shown in FIG. 13 and FIG. 14, the gap error signal is generated on the basis of only the evanescent light MBE associated with the main beam. Here, for example, if the evanescent light MBE associated with the main beam is alternately applied to the groove track and the land track L in a seek operation, it is influenced by the variations in height due to the concave pit PT1 formed in the land track L. If so, as shown in the top in FIG. 13, noise is generated in a signal which indicates a change in intensity of the gap error signal GE (hereinafter also referred to as a radial contrast signal) in case that the irradiation position of the evanescent light MBE associated with the main beam is displaced in the radial direction. Even if the noise is removed by a low pass filter LPF, as shown in the middle in FIG. 13 and FIG. 14, the intensity of the gap error signal GE periodically changes due to the alternate presence of the groove track G and the land track L. In this case, for example, in the seek operation, even if it is tried to maintain the gap constant between the solid-immersion lens 21 and the recording medium 100 in practice, the intensity of the gap error signal GE periodically changes, so that the gap actuator 210 is driven in small motions in accordance with the periodical change.

On the other hand, according to the information recording/reproducing apparatus 1 in the fourth embodiment, as shown in FIG. 15 and FIG. 16, the gap error signal is generated on the basis of not only the evanescent light MBE associated with the main beam but also the evanescent light SBE associated with the sub beam SB. Here, particularly in the embodiment, the optical condition of the optical system is set such that the evanescent light SBE associated with the sub beam SB is applied to the land track L when the evanescent light MBE associated with the main beam is applied to the groove track G. Alternatively, the optical condition of the optical system is set such that the interval of the both evanescent lights in the radial direction of the recording medium 100 between the irradiation positions is narrower than that of the adjacent groove tracks G. In any case, the both evanescent lights have different irradiation positions in the radial direction. Thus, the radial contrast signals have mutually different phases on the basis of the amounts of return lights of the both evanescent lights. Preferably, as shown in FIG. 16, the optical condition of the optical system is set such that the main gap error signal GE based on the amount of the evanescent light MBE associated with the main beam received by the main light receiving device 312 and the sub gap error signal GE based on the amount of the evanescent light SBE associated with the sub beam SB outputted from the summing amplifier 3141 have reversed phases, and the magnification of the summing amplifier 3141 is set such that two gap error signals GE have the approximately same amplitude. If so, the change in intensity of the gap error signal GE caused by the difference in the physical or optical height between the tracks is canceled by the adder 3142. This can stabilize the gap servo control. For example, if the gap between the solid-immersion lens 21 and the recording medium 100 is constant in practice in the seek operation, the gap error signal GE eventually outputted from the adder 3142 has approximately constant intensity, so that the gap actuator 210 is not wastefully driven.

### (5) Fifth Embodiment

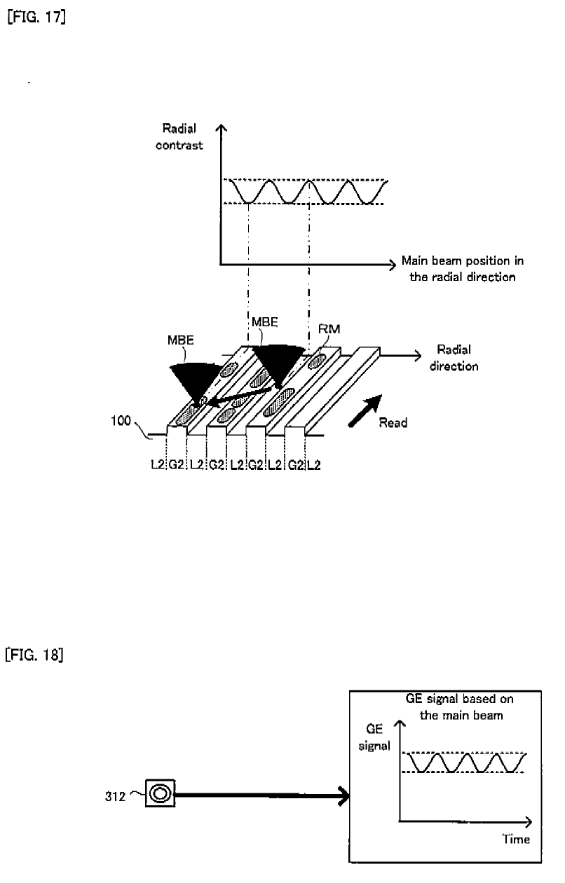

Next, the basic structure and the operation of an information recording/reproducing apparatus 1 in a fifth embodiment will be explained with reference to FIG. 17 to FIG. 20. In each drawing, the same constituents as those in any of FIG. 1 to FIG. 16 will carry the same referential numerals, and the detailed explanation thereof will be omitted as occasion demands.

PIG. 17 is a schematic diagram showing the placement of evanescent light on the recording medium 100, in a comparative example. FIG. 18 is a characteristic diagram showing the signal level of the gap error signal GE obtained on an information recording/reproducing apparatus in the comparative example.

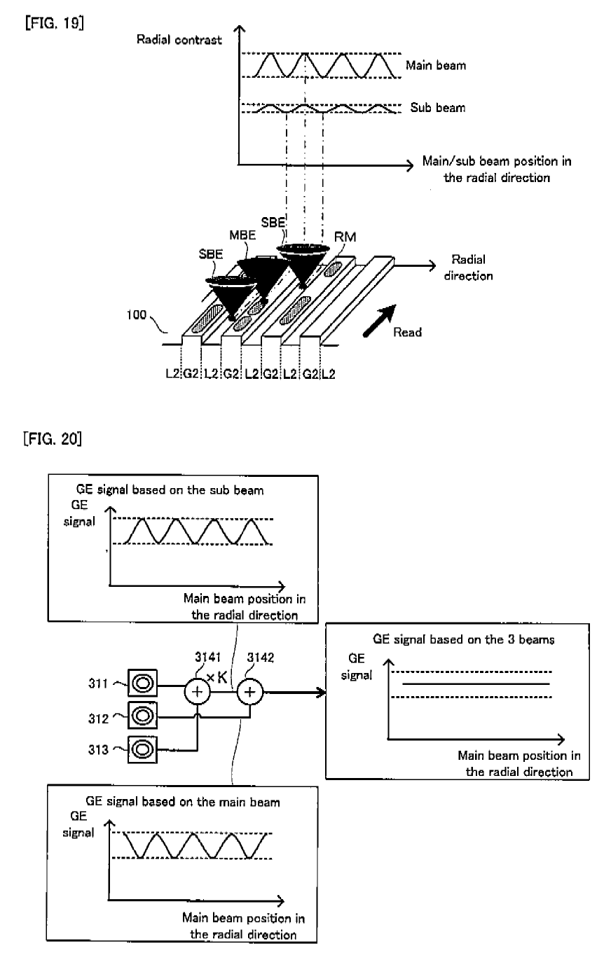

FIG. 19 is a schematic diagram showing the placement of evanescent light on the recording medium 100, in a fifth embodiment. FIG. 20 is a characteristic diagram showing the signal level of the gap error signal GE obtained on the information recording/reproducing apparatus 1 in the fifth embodiment.

The fifth embodiment is an embodiment for individually and specifically explaining that the benefits shown in the fourth embodiment are effective in a recording surface of a land/groove type on which the recording pit is formed as a recording mark RM.

In FIG. 17 and FIG. 19, in a groove track G2, there are variations in optical height in accordance with the presence or absence of the recording mark RM. In addition, the groove track G2 is a track in which the recording mark RM is formed and a groove with a predetermined depth. Thus, there is a difference in physical height between the groove track G2 and a land track L2.

Here, firstly, in the comparative example, as shown in FIG. 17 and FIG. 18, the gap error signal is generated on the basis of only the evanescent light MBE associated with the main beam. If so, as in the comparative example shown in FIG. 13 and FIG. 14, when the irradiation position of the evanescent light MBE associated with the main beam is displaced in the radial direction, the intensity of the gap error signal GE periodically changes due to the alternate presence of the groove track G2 and the land track L2. Incidentally, even if there is no difference in physical height between the groove track G2 and the land track L2, the intensity of the gap error signal GE periodically changes due to a difference in optical height.

On the other hand, according to the information recording/reproducing apparatus 1 in the fifth embodiment, as shown in FIG. 19 and FIG. 20, the gap error signal is generated on the basis of not only the evanescent light MBE associated with the main beam but also the evanescent light SBE associated with the sub beam. Here, particularly in the embodiment, the optical condition of the optical system is set such that the evanescent light SBE associated with the sub beam SB is applied to the land track L2 when the evanescent light MBE associated with the main beam is applied to the groove track G2. Alternatively, the optical condition of the optical system is set such that the interval of the both evanescent lights in the radial direction of the recording medium 100 between the irradiation positions is narrower than that of the adjacent groove tracks G2. If so, as in the fourth embodiment, the change in intensity of the gap error signal GE caused by the difference in the physical or optical height between the tracks is canceled. This can stabilize the gap servo control.

Incidentally, in the aforementioned embodiments, the laser diode 11 is a specific example of the “light source”. The collimator lens 12 to the reflecting mirror 19 are specific an example of the “optical system”. The diffraction grating 14 is a specific example of the “diffracting device”. The solid-immersion lens 21 is a specific example of the “evanescent light generating device”. The sub light receiving devices 311 and 313 are a specific example of the “sub light receiving device”. The main light receiving devices 312 is a specific example of the “main light receiving device”. The gap actuator 210 is a specific example of the “displacing device”. The amplifier 315 is a specific example of the “controlling device”.

Incidentally, the present invention is not limited to the aforementioned embodiments, but various changes may be made, if desired, without departing from the essence or spirit of the invention which can be read from the claims and the entire specification. An information recording/reproducing apparatus, which involves such changes, is also intended to be within the technical scope of the present invention.

### INDUSTRIAL APPLICABILITY

The information recording/reproducing apparatus of the present invention can be applied to an information recording/reproducing apparatus for high-density optical discs which uses evanescent light. Moreover, the present invention can be also applied to an information recording/reproducing apparatus or the like which is mounted on or connected to various computer equipment for consumer use or for commercial use,

1. An information recording/reproducing apparatus for performing recording or reproducing of information by applying an evanescent light onto a recording medium, said information recording/reproducing apparatus comprising:
a light source for emitting a laser beam corresponding to the recording or the reproduction;
an optical system for leading the emitted laser beam onto the recording medium;
a diffracting device, disposed on an optical path of the laser beam in said optical system, for diffracting the led laser beam to be separated into a main beam and a sub beam;
an evanescent light generating device for (i) applying an evanescent light associated with the main beam onto a track, where a recording pit is formed, of a plurality of tracks disposed at a recording surface of the recording medium, and (ii) applying an evanescent light associated with the separated sub beam onto a track, which is disposed at the recording surface and where a recording pit is not formed;
a sub light receiving device for receiving a return light associated with the sub beam;
a main light receiving device for receiving a return light associated with the main beam;
a displacing device for displacing said evanescent light generating device in such a direction as to change a gap between the recording surface and said evanescent light generating device; and
a controlling device for controlling said displacing device in such a manner that the gap can have a predetermined target value, on the basis of a gap error signal which is provided with a light amount of the received return light associated with the sub beam and a light amount of the received return light associated with the main beam.

2. The information recording/reproducing apparatus according to claim 1, further comprising an amplifying device for amplifying the light amount of the return light associated with the sub beam at a predetermined magnification.

3. The information recording/reproducing apparatus according to claim 2, wherein the predetermined magnification is set to a value which exceeds a value obtained by dividing the light amount of the received return light associated with the main beam by the light amount of the received return light associated with the sub beam.

4. The information recording/reproducing apparatus according to claim 2, wherein the predetermined magnification is set to a value obtained by dividing the light amount of the received return light associated with the main beam by the light amount of the received return light associated with the sub beam.

5. The information recording/reproducing apparatus according to claim 1, wherein the recording pit is formed in a concave shape.

6. The information recording/reproducing apparatus according to claim 1, further comprising a signal generating device, disposed at the optical path of the laser beam in said optical system, for generating the gap error signal corresponding to a magnitude of the gap between the evanescent light generating device and the recording surface.

7. The information recording/reproducing apparatus according to claim 1, wherein if the track where the recording pit is formed and the track where the recording pit is not formed are alternately placed in the recording medium, an optical condition in said optical system is set such that a difference between an irradiation position on the recording surface of the evanescent light associated with the separated sub beam and an irradiation position on the recording surface of the evanescent light associated with the main beam is an odd multiple of a half value of a track pitch in a radial direction of the recording medium.

8. The information recording I reproducing apparatus according to claim 1, wherein said evanescent light generating device is a solid-immersion lens or a solid-immersion mirror.

9. The information recording/reproducing apparatus according to claim 1, wherein said diffracting device separates the sub beam into at least ±first-order lights, and the gap error signal is generated at least from the ±first-order
